(19) United States
(12) Patent Application Publication
(10) Pub. No.: US 2026/0287564 A1
(43) Pub. Date: Sep. 24, 2026

(54) LIQUID CHROMATOGRAPH SYSTEM AND CONTROL METHOD

(71) Applicant: SHIMADZU CORPORATION, Kyoto (JP)

(72) Inventors: Tomohiro SHAGAWA, Columbia, MD (US); Kerry HILL, Columbia, MD (US); Timothy LEE, Columbia, MD (US)

(73) Assignee: SHIMADZU CORPORATION, Kyoto (JP)

(21) Appl. No.: 19/475,513

(22) PCT Filed: Mar. 21, 2024
(86) PCT No.: PCT/JP2024/010996

§ 371 Date: Oct. 15, 2025

Related U.S. Application Data
(60) Provisional application No. 63/459,716, filed on Apr. 17, 2023.

(51) Int. Cl. G01N 30/46; G01N 30/02; G01N 30/06; G01N 30/16

(52) U.S. Cl. CPC G01N 30/466; G01N 30/06; G01N 30/16; G01N 2030/027; G01N 2030/065; G01N 2030/167

(57) ABSTRACT

In a liquid chromatograph system (10), a plurality of streams (60A, 60B, 60C, 60D) separate a sample. A sample injection device (18) injects a sample into each of the plurality of streams (60A, 60B, 60C, 60D). A detector (500) is disposed downstream of the plurality of streams (60A, 60B, 60C, 60D) and analyzes the sample separated in each of the plurality of streams (60A, 60B, 60C, 60D). A control device (110) stores, for each sample, analysis conditions for separating the sample. The plurality of streams (60A, 60B, 60C, 60D) include at least two streams having stream configurations related to sample separation that are different from each other. The control device (110) selects a stream having a stream configuration corresponding to the analysis conditions of the sample from among the plurality of streams.

### TECHNICAL FIELD

The present disclosure relates to a liquid chromatograph system and a control method, and more particularly, to a technology concerning the assignment of analyses in a liquid chromatograph system having a plurality of streams.

### BACKGROUND ART

Liquid chromatography is a technique for separating components contained in a sample by introducing the sample into a column together with a mobile phase (eluent). The components of the sample separated by liquid chromatography are analyzed by a detector such as a mass spectrometer.

U.S. Patent Application Publication No. 2022/0137011 (Patent Literature 1) and “Nexera QX,” Shimadzu Corporation (Non-Patent Literature 1) describe an analysis system comprising a plurality of streams, each including a plurality of columns. The analysis system described in Patent Literature 1 and Non-Patent Literature 1 connects any one of the plurality of streams to a mass spectrometer by a valve having a plurality of ports connected to the mass analysis device.

### PRIOR ART DOCUMENTS

### Patent Literature

Patent Literature 1: U.S. Patent Application Publication No. 2022/0137011

### Non-Patent Literature

Non-Patent Literature 1: “Nexera QX,” [online], [searched Dec. 14, 2022], Shimadzu Corporation, Internet <URL: https://www.ssi.shimadzu.com/products/liquid-chromatography-mass-spectrometry/ultrafast-multiplex-lcms-nexera-qx.html>

### SUMMARY OF INVENTION

### Problem to be Solved by the Invention

According to the analysis systems described in Patent Literature 1 and Non-Patent Literature 1, analysis efficiency can be increased by continuing mass analysis using a plurality of streams. However, even in an analysis system including a plurality of streams, the configuration of each stream (for example, the type of mobile phase, the type of column) may differ, and depending on the stream, it may not be possible to analyze samples with different analysis conditions.

An object of the present disclosure is to efficiently analyze samples with different analysis conditions using a liquid chromatograph system including a plurality of streams.

### Means for Solving the Problem

A liquid chromatograph system according to an aspect of the present disclosure is a liquid chromatograph system for performing analysis of a plurality of samples. The liquid chromatograph system comprises a plurality of streams, a sample injection device, a detector, and a control device. The plurality of streams separate samples. The sample injection device injects a sample into each of the plurality of streams. The detector is disposed downstream of the plurality of streams and analyzes the sample separated in each of the plurality of streams. The control device stores, for each sample, analysis conditions for separating the sample. Each of the plurality of streams includes a column and a supply device. The column separates the sample injected into the stream. The supply device supplies a mobile phase used in the column. The plurality of streams include at least two streams having stream configurations related to sample separation that are different from each other. The control device selects a stream having a stream configuration corresponding to the analysis conditions of the sample from among the plurality of streams.

A control method for a liquid chromatograph system according to another aspect of the present disclosure is a control method for a liquid chromatograph system for performing analysis of a plurality of samples, executed by a computer. The liquid chromatograph system comprises a plurality of streams, a sample injection device, and a detector. The plurality of streams separate samples. The sample injection device injects a sample into each of the plurality of streams. The detector is disposed downstream of the plurality of streams and analyzes the sample separated in each of the plurality of streams. Each of the plurality of streams includes a column and a supply device. The column separates the sample injected into the stream. The supply device supplies a mobile phase used in the column. The plurality of streams include at least two streams having stream configurations related to sample separation that are different from each other. The control method comprises a step of selecting a stream having a stream configuration corresponding to the analysis conditions for separating the sample from among the plurality of streams, and a step of executing the analysis of the sample in the selected stream.

### Advantageous Effects of Invention

According to the present disclosure, it is possible to efficiently analyze samples with different analysis conditions using a liquid chromatograph system including a plurality of streams.

### BRIEF DESCRIPTION OF DRAWINGS

FIG. 1 is a schematic configuration diagram of a liquid chromatograph system.

FIG. 2 is a diagram for explaining a sample plate.

FIG. 3 is a schematic configuration diagram of a stream.

FIG. 4 is a diagram for explaining the configuration of a control device.

FIG. 5 is a flowchart showing a process related to the control of the liquid chromatograph system.

FIG. 6 is a flowchart for explaining a stream-based analysis assignment process.

FIG. 7 is a flowchart for explaining a batch-based analysis assignment process.

FIG. 8 is a flowchart for explaining a plate-based analysis assignment process.

FIG. 9 is a flowchart for explaining a priority analysis execution process.

FIG. 10 is an example of a display screen showing the progress status of all analyses.

### DESCRIPTION OF EMBODIMENTS

Hereinafter, embodiments of the present disclosure will be described in detail with reference to the drawings. In the drawings, the same or corresponding parts are denoted by the same reference numerals, and description thereof will not be repeated.

### 1. Overall System Configuration

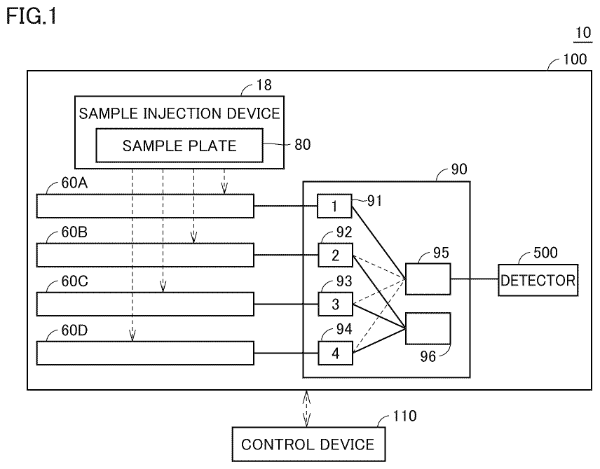

FIG. 1 is a schematic configuration diagram of a liquid chromatograph system (hereinafter, LC (Liquid Chromatography) system) 10. The LC system 10 includes an analysis device 100 and a control device 110.

The analysis device 100 separates and analyzes components contained in a sample. The analysis device 100 comprises a sample injection device 18, a plurality of analysis flow paths (hereinafter referred to as “streams”) 60A to 60D, a divert valve 90, and a detector 500.

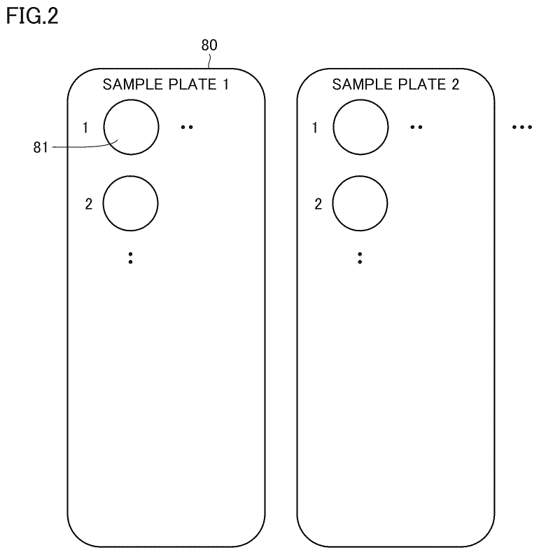

The sample injection device 18 is a device for injecting a sample into each of the streams 60A to 60D. The sample injection device 18 is, for example, an autosampler and includes one or more sample plates 80 (see FIG. 2) capable of accommodating one or more samples, and a needle (not shown). One sample injection device 18 typically includes several or more sample plates 80. Each sample plate 80 is managed, for example, by a plate number. One sample plate 80 accommodates, for example, about 10 to several hundred samples. The sample plate 80 may be configured to accommodate samples stored in containers such as vials, or may be configured to directly accommodate samples without containers, such as a microplate. Each sample plate 80 is usually assigned a sample number corresponding to the position where a sample is accommodated. For example, the sample accommodated at the position indicated by 81 in FIG. 2 is distinguished from other samples as the sample with plate number 1 and sample number 1. The needle aspirates a predetermined sample instructed by the control device 110 from the sample plate 80 and injects the aspirated sample into a predetermined stream instructed by the control device 110.

The streams 60A to 60D are flow paths provided for separating a sample, and a mobile phase flows through them. Each of the streams 60A to 60D is connected to the detector 500 via the divert valve 90.

The divert valve 90 comprises ports 91 to 96. The streams 60A to 60D are connected to the ports 91 to 94, respectively. The detector 500 is connected to the port 95. A waste liquid pipe (not shown) is connected to the port 96. The divert valve 90 fluidically connects any one of the streams 60A to 60D to the detector 500 by switching the connection destination of each of the ports 91 to 94 to either the port 95 or the port 96.

The detector 500 is a device disposed downstream of the streams 60A to 60D and analyzes the sample separated in each of the streams 60A to 60D. In one embodiment, the detector 500 is a mass spectrometer that performs mass analysis on the sample. The detector 500 is not limited to a mass spectrometer and may be an absorbance detector, a fluorescence detector, a differential refractive index detector, an electrical conductivity detector, an evaporative light scattering detector, or the like, and is not particularly limited.

As described above, in the LC system 10, by connecting the plurality of streams 60A to 60D in parallel and connecting them to the detector 500 via the divert valve 90, it is possible to execute the separation of samples using each of the streams 60A to 60D in parallel.

### 2. Stream Configuration

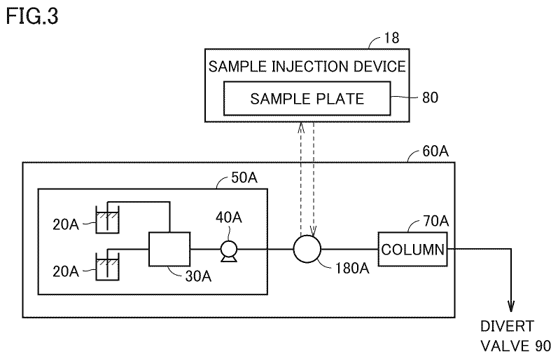

Next, the configuration of the stream 60A will be described with reference to FIG. 3. The stream 60A includes a column 70A, a supply device 50A, and a valve 180A. The mobile phase is sent from the supply device 50A toward the column 70A, passes through the column 70A, and is sent to the divert valve 90.

The supply device 50A is a device for supplying the mobile phase used in the column 70A. In the example of FIG. 3, the supply device 50A supplies the mobile phase flowing through the stream 60A. The supply device 50A includes a plurality of mobile phase containers 20A, a mixer 30A, and a mobile phase pump 40A.

The plurality of mobile phase containers 20A are containers that respectively store a predetermined type of mobile phase. The mobile phase stored in the mobile phase containers 20A is used as an eluent for separating the sample in the column 70A. In one embodiment, the types of mobile phases stored in each of the plurality of mobile phase containers 20A are different from each other. However, at least two of the mobile phases stored in each of the plurality of mobile phase containers 20A may be the same. The type of mobile phase includes, but is not limited to, for example, types of mobile phases within a range commonly used by those skilled in the art, such as water, acetonitrile, methanol, organic acids of a predetermined concentration, acetone, and the like. The type of mobile phase also includes those prepared by pre-mixing at least two of water, acetonitrile, methanol, organic acids of a predetermined concentration, acetone, etc., at a predetermined mixing ratio. The mobile phase container corresponds to an embodiment of a “container.”

The mixer 30A mixes the mobile phases from the plurality of mobile phase containers 20A at a set mixing ratio. The mixing ratio includes 0:100. The mixing ratio is set, for example, by the control device 110 based on the analysis conditions of the sample to be separated. The mixing ratio may be set to be constant during the analysis of the sample, or may be set to change over time during the analysis.

The mixer 30A may mix the mobile phases stored in all the mobile phase containers 20A included in the stream 60A, but may also mix only the mobile phases stored in at least two of the mobile phase containers 20A. Also, only the mobile phase stored in one of the mobile phase containers 20A may be used. In these cases, the mixing ratio of the unmixed mobile phase is 0.

As will be described later, in the LC system 10, the number of mobile phase containers provided in each supply device may be one, and in that case, it is not necessary to install a mixer.

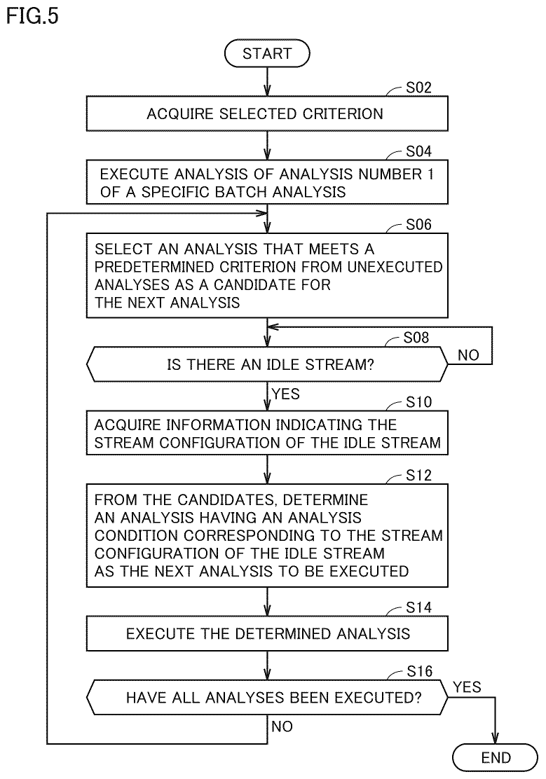

The mobile phase pump 40A is a pump for supplying the mobile phase to the column 70A at a predetermined pressure. In the example of FIG. 3, the mobile phase pump 40A sends the mixed liquid mixed by the mixer 30A as a mobile phase toward the valve 180A. The mobile phase pump 40A corresponds to an embodiment of a “pump” in this specification. In the example of FIG. 5, one mobile phase pump is connected downstream of the mixer 30A, but one mobile phase pump may be provided between each of the plurality of mobile phase containers 20A and the mixer 30A.

The valve 180A switches the flow path connected to the supply device 50A between a flow path connected to the column 70A passing through the sample injection device 18 and a flow path connected to the column 70A without passing through the sample injection device 18. If the flow path in which the supply device 50A, the sample injection device 18, and the column 70A are connected in series in this order is referred to as an “injection flow path,” and the flow path in which the supply device 50A and the column 70A are connected in series in this order without passing through the sample injection device 18 is referred to as a “direct flow path,” then it can be said that the valve 180A performs switching between the injection flow path and the direct flow path.

The column 70A separates the sample injected into the stream 60A. The column 70A is packed with a stationary phase for separating the components of the sample.

The configuration of the stream 60A has been described in detail above. The configurations of the streams 60B to 60D are the same as that of the stream 60A in that they include an injection path and a direct flow path, and include a mobile phase container, a mobile phase pump, a high-pressure valve, and a column. However, at least two of the streams 60A to 60D may have stream configurations related to sample separation that are different from each other.

The stream configuration includes, for example, the type of mobile phase. In other words, the type of mobile phase included in each stream may be different from each other. The case where the types of mobile phases between streams are different from each other includes, for example, a case where a type 1 mobile phase and a type 2 mobile phase are used in stream 60A, and only a type 1 mobile phase is used in stream 60B. In this example, since stream 60B has one mobile phase container, it is not necessary to provide a mixer. The stream configuration may include, for example, the type of column. In other words, the type of column included in each stream may be different from each other. “The types of columns being different from each other” includes, for example, that at least one of the type of column packing material, its chemical modification, particle size, length, and diameter is different from each other. The user can use different types of columns depending on the application. The column is, for example, a C18 column or a C8 column. C18 columns and C8 columns are reversed-phase HPLC columns containing different types of packing materials.

The control device 110 can switch the stream used for sample separation among the streams 60A to 60D. Therefore, according to the LC system 10, various samples can be continuously analyzed in the detector 500.

In particular, because the stream configurations of the streams 60A to 60D are different, samples with different conditions for separating the sample (referred to as “analysis conditions” in this specification) can also be analyzed with a single analysis system. The analysis conditions are, for example, at least one of the type of mobile phase supplied to the column and the type of column. The analysis conditions may include other conditions such as the column temperature control, the mixing ratio of the mobile phase, and the like. Each analysis condition may be stored and managed in the control device 110, or may be managed by the user without being stored in the control device 110. The control device 110 or the user selects a stream having a stream configuration corresponding to the analysis conditions of the sample from among the streams 60A to 60D. This allows the analysis to be performed under analysis conditions suitable for each sample. Furthermore, the control device 110 can perform sample separation in parallel in a plurality of streams and analyze each of the separated samples with the detector 500 during different periods. In this way, by the control device 110 appropriately assigning the separation of each sample to each stream, each stream can be used efficiently.

### 3. Control Device Configuration

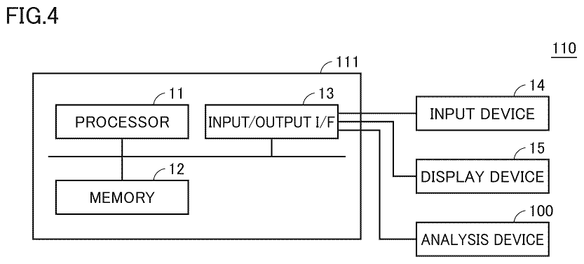

FIG. 4 is a diagram for explaining the configuration of the control device 110. The control device 110 comprises a main body 111, an input device 14, and a display device 15.

The main body 111 comprises a processor 11, a memory 12, and an input/output interface (I/F) 13. The processor 11 is typically an arithmetic processing unit such as a CPU (Central Processing Unit) or an MPU (Multi-Processing Unit). The processor 11 reads and executes a program stored in the memory 12 to realize the processing of the LC system.

The memory 12 is realized by a RAM (Random Access Memory), a ROM (Read Only Memory), and a non-volatile memory such as a flash memory. The memory 12 may be constituted by a CD-ROM (Compact Disc-Read Only Memory), a DVD-ROM (Digital Versatile Disk-Read Only Memory), a USB (Universal Serial Bus) memory, a memory card, an FD (Flexible Disk), a hard disk, an SSD (Solid State Drive), a magnetic tape, a cassette tape, an MO (Magnetic Optical Disc), an MD (Mini Disc), an IC (Integrated Circuit) card (excluding memory cards), an optical card, a mask ROM, or an EPROM, as long as it can non-temporarily record a program in a format readable by the processor 11. The memory 12 stores, for each sample, analysis conditions for separating the sample.

The input/output I/F 13 is an interface for exchanging various data between the processor 11 and external devices connected to the input/output I/F 13. The external devices include the input device 14 and the display device 15.

The input device 14 is constituted by, for example, a keyboard and a mouse. The user can input various instructions to the control device 110 by operating the input device 14.

The display device 15 displays an image corresponding to a video signal output by the control device 110. The display device 15 is, for example, a display.

### 4. Comparison with Conventional Liquid Chromatograph Systems

Patent Literature 1 and Non-Patent Literature 1 disclose an analysis system comprising an autosampler that performs pretreatment and post-treatment of a sample, a plurality of streams that separate components present in the pretreated sample, and a mass spectrometer that detects the separated components. Such an analysis system is also called a multiplex liquid chromatograph system (Multiplex LC-MS (Liquid Chromatography-Mass spectrometry) System).

According to the analysis systems described in Patent Literature 1 and Non-Patent Literature 1, throughput can be improved by separating a plurality of samples in parallel using a plurality of streams. However, even if there are a plurality of streams, if the configurations related to analysis conditions for sample separation, such as the columns and mobile phases incorporated in each of the plurality of streams (stream configurations), are the same, it was sometimes not possible to analyze samples having different analysis conditions with a single analysis system.

In view of the above circumstances, the LC system 10 according to the present embodiment includes a plurality of streams with different stream configurations related to the analysis conditions of the sample. This makes it possible to analyze samples with mutually different analysis conditions, such as samples that use different types of columns for separation, with a single system. That is, the LC system 10 is a system that can also appropriately handle a plurality of analysis conditions (multi-method)

In addition, the method of assigning an analysis to each stream in the LC system 10 is also different from that of a conventional analysis system in which the stream configurations of all streams are the same. In such a conventional analysis system, it was a matter of course that the streams that could be used for any analysis were the same. On the other hand, in the LC system 10, the analysis conditions that can be handled differ for each stream. Therefore, in the LC system 10, the control device 110 performs a process of appropriately assigning analyses to each stream according to a predetermined criterion. Furthermore, in the LC system 10, the user can select the criterion according to their purpose.

### 5. Assignment of Analysis in the LC System According to the Embodiment

Next, the assignment of analysis in the LC system 10 will be described with a specific example.

### (5-1. Method for Determining Analysis Conditions Feasible in Each Stream)

First, a method by which the control device 110 determines the analysis conditions that can be performed in each stream will be described.

In this example, the LC system 10 includes streams 1 to 4. And for each stream, the stream configuration (combination of column type and mobile phase type) is different.

For example, in stream 1, a type 1 column is installed, and as for the mobile phase, type 1, type 2, and type 3 mobile phases are stored in three mobile phase containers, respectively. On the other hand, in stream 2, a type 2 column is installed, and as for the mobile phase, type 1, type 2, type 3, and type 4 mobile phases are stored in four mobile phase containers, respectively.

Table 1 below summarizes the stream configurations of streams 1 to 4, including streams 1 and 2 mentioned above, in this example.

TABLE 1

| Stream | Column Type | Mobile Phase Type |
|---|---|---|
| Stream 1 | 1 | 1, 2, 3 |
| Stream 2 | 2 | 1, 2, 3, 4 |
| Stream 3 | 2 | 1, 2, 3, 4 |
| Stream 4 | 1 | 1, 3 |

Next, consider the case where the following four types of analyses with mutually different analysis conditions are performed in the LC system 10 including the above-mentioned streams 1 to 4.

For example, analysis condition 1 is a condition in which a type 1 column is used, and as for the mobile phase, type 1 and type 2 mobile phases are mixed and used.

Table 2 below summarizes the four analysis conditions, including analysis condition 1 mentioned above, in this example.

TABLE 2

| Analysis Condition | Required Column | Required Mobile Phase |
|---|---|---|
| Analysis Condition 1 | 1 | 1, 2 |
| Analysis Condition 2 | 1 | 1, 3 |
| Analysis Condition 3 | 2 | 1, 2 |
| Analysis Condition 4 | 2 | 3, 4 |

The control device 110 acquires the unit configurations of streams 1 to 4 and analysis conditions 1 to 4. Then, by comparing the unit configurations of streams 1 to 4 and analysis conditions 1 to 4, it determines the feasible analysis conditions for each stream. Specifically, when the stream configuration of a predetermined stream satisfies a predetermined analysis condition, the control device 110 determines that the predetermined analysis condition can be performed in the predetermined stream. In this specification, the fact that a predetermined analysis condition can be performed in a predetermined stream configuration is also referred to as “the analysis condition corresponds to the stream configuration.”

From the above, the analysis conditions that can be performed in each stream are as shown in Table 3 below.

TABLE 3

| Stream | Feasible Analysis Condition |
|---|---|
| Stream 1 | Analysis Conditions 1, 2 |
| Stream 2 | Analysis Conditions 3, 4 |
| Stream 3 | Analysis Conditions 3, 4 |
| Stream 4 | Analysis Condition 2 |

The control device 110 assigns an analysis to each stream according to a predetermined criterion, which will be described later, based on the determined feasible analysis conditions for each stream. For example, when stream 1 is a stream that is not performing an analysis (hereinafter also referred to as an “idle stream”), the control device 110 assigns an analysis of analysis condition 1 or analysis condition 2. With this configuration, when a previous analysis in a stream is completed and it becomes an idle stream, an analysis that can be performed in that idle stream can be searched for and started. This allows the stream to be used effectively, thereby improving the throughput of the analysis device 100.

The process of assigning a feasible analysis condition to each stream may be performed by the control device 110 as in the above example, or the user may input and store an assignment conceived by the user into the control device 110.

### (5-2. Management of Sample Information for Each Batch Analysis)

In one embodiment, analyses are managed in a bundle of a plurality of analyses called a batch analysis. The plurality of analyses in a batch analysis are usually assigned an analysis number for management. A batch analysis is usually an analysis in which at least one of the elements related to the analysis, such as collection date and time, analysis purpose, analysis executor, analysis requester, etc., is the same. By managing these related analyses collectively as a batch analysis, the management of analyses becomes easier than when individual analyses are managed separately. In this specification, all the batch analyses performed at once in the LC system 10 are described as “all analyses.”

In the control device 110, sample information is associated with and stored for each analysis included in a batch analysis. The sample information includes at least a plate number, a sample number, and an analysis condition corresponding to the sample. The sample information may also include other information such as a sample name, a sample ID, collection date and time, analysis purpose, analysis executor, analysis requester, etc.

The plate number, sample number, and analysis condition for each analysis included in a batch analysis are registered in the LC system 10, for example, as shown in Table 4 below. Hereinafter, the number of a batch analysis is described as a “batch number.” Also, analysis number 1 of the batch analysis with batch number 1 is denoted as analysis 1-1. Although the same analysis conditions are often set for a plurality of analyses in a batch analysis, mutually different analysis conditions may be set as in the example of Table 4.

Table 4 below shows the plate number, sample number, and analysis condition of the sample corresponding to each analysis included in batch analyses 1 and 2.

TABLE 4

| Analysis | Plate No. | Sample No. | Analysis Condition |
|---|---|---|---|
| Analysis 1-1 | 1 | 1 | 1 |
| Analysis 1-2 | 1 | 2 | 2 |
| Analysis 1-3 | 2 | 1 | 1 |
| Analysis 1-4 | 2 | 2 | 2 |
| Analysis 2-1 | 1 | 3 | 1 |
| Analysis 2-2 | 1 | 4 | 2 |
| Analysis 2-3 | 3 | 1 | 3 |
| Analysis 2-4 | 3 | 2 | 4 |

Referring to Table 4, for example, analysis 1-1 is the analysis of sample number 1 on plate number 1, and its analysis condition is 1.

The control device 110 acquires the plate number, sample number, analysis condition, etc., from the sample information registered for each analysis as described above. Then, as will be described later, based on a predetermined criterion based on the analysis number, plate number, etc., it assigns the analysis to a stream corresponding to the analysis condition. As described above, the control device 110 can select an appropriate stream and perform the analysis even when there are analyses with mutually different analysis conditions in an analysis managed in a batch format.

### (5-3. Criteria for Assigning Analyses)

In the LC system 10, the user can select the criterion for assigning the above-mentioned analyses according to their purpose. The selection of the criterion is performed, for example, using the input device 14.

### (5-3-1. Batch-Based Criterion)

For example, when the user desires analysis for each batch analysis, the control device 110 performs all analyses of one batch analysis and then performs all analyses of the next batch analysis. In other words, the control device 110 sets an unexecuted analysis within the batch analysis that includes the currently executing analysis as a candidate for the next analysis. For example, in the above example, after analyses 1 to 4 of batch analysis 1 are executed, analyses 1 to 4 of batch analysis 2 are executed. Such a criterion is referred to as a “batch-based criterion” in this specification. The batch-based criterion corresponds to an embodiment of a “second criterion.”

When performing analysis on a batch basis, it is easy for the user to understand up to which batch analysis has been completed.

In addition, as described above, since elements related to analysis such as analysis date and time, analysis purpose, analysis executor, analysis requester, etc., are often common in a batch analysis, all analysis results within a batch analysis are often used together. Therefore, there is a merit that as soon as all analyses within a predetermined batch analysis are completed, the analysis results of that predetermined batch analysis can be used without waiting for the analyses of all batch analyses to be completed. In other words, as soon as the analysis for a batch analysis unit is completed, the results can be used sequentially.

In one embodiment, the control device 110 executes analyses in ascending order of analysis number within a batch analysis. In this case, there is a merit that it is easy for the user to know how far the analysis has progressed within the batch analysis. However, the control device 110 may execute an analysis having an analysis condition corresponding to an idle stream from among the analyses in the batch analysis being executed, regardless of the analysis number. In this case, the stream can be used more effectively compared to the case of performing analyses in order of analysis number within the batch analysis. For example, in the case where analyses up to analysis 2-1 in the above example have been executed, if a stream corresponding to analysis condition 3 becomes an idle stream, analysis 2-3 can be executed, skipping analysis 2-2.

### (5-3-2. Plate-Based Criterion)

When the user desires analysis for each sample plate 80, the control device 110 performs the analysis of all samples accommodated in one sample plate 80, and then performs the analysis of all samples accommodated in the next sample plate 80. In other words, the control device 110 sets an unexecuted analysis from among the sample plates that contained the sample of the currently executing analysis as a candidate for the next analysis. For example, in the above example, after analyses 1-1, 1-2, 2-1, and 2-2 accommodated in the sample plate 80 with plate number 1 are executed, analyses 1-3 and 1-4 accommodated in the sample plate 80 with plate number 2 are executed. Such a criterion is referred to as a “plate-based criterion” in this specification. The plate-based criterion corresponds to an embodiment of a “third criterion.”

When performing analysis on a plate basis, it is easy for the user to understand up to which sample plate 80 the analysis has been completed.

In addition, similar to batch analyses, elements related to analysis such as analysis date and time, analysis purpose, analysis executor, analysis requester, etc., are often common for a sample plate 80 as well. For example, there are cases where a series of samples having a predetermined analysis purpose are sequentially accommodated on plate number 1 for each day the samples were acquired, and a series of samples having another analysis purpose are sequentially accommodated on plate number 2 for each day the samples were acquired. In this way, at least a part of the analysis results of samples accommodated on the same sample plate 80 are also often used together. Therefore, there is a merit that as soon as the analysis of all samples in a predetermined sample plate 80 is completed, the analysis results of the samples in the predetermined sample plate 80 can be used without waiting for the analysis of all samples in all sample plates 80 to be completed. In other words, as soon as the analysis for a sample plate 80 unit is completed, the results can be used sequentially.

In one embodiment, the control device 110 executes analyses in ascending order of sample number on the sample plate 80. In this case, there is a merit that it is easy for the user to know up to which sample number the analysis has progressed within the sample plate 80. However, the control device 110 may execute the analysis from a sample with an analysis condition corresponding to an idle stream on the sample plate 80 containing the sample being analyzed, regardless of the sample number. In this case, the stream can be used more effectively compared to the case of performing analyses in order of sample number on the sample plate 80.

### (5-3-3. Stream-Based Criterion)

When the user places the highest priority on the throughput of the LC system 10 as a whole, the control device 110, in order to increase the operating rate of each stream, searches for an analysis that can be performed in an idle stream from among all unexecuted analyses included in all batch analyses, and executes the analysis. In other words, the control device 110 selects an unexecuted analysis from the analyses included in the batch analyses for each batch analysis and sets it as a candidate for the next analysis. A criterion that prioritizes the operating rate of the stream in this way is referred to as a “stream-based criterion” in this specification. The stream-based criterion corresponds to an embodiment of a “first criterion.” When performing analysis on a stream basis, the time required to execute all analyses can be further shortened compared to each of the batch-based criterion and the plate-based criterion.

In one embodiment, the control device 110, in each batch analysis, selects the analysis with the smallest analysis number among the unexecuted analyses as a candidate for the analysis to be executed in the idle stream. Then, it determines the analysis to be executed in the idle stream from the selected candidates. In this case, since the analyses proceed in order of analysis number within each batch analysis, there is a merit that it is easy for the user to know how far the analysis has progressed within the batch analysis. However, the control device 110 may also select an analysis having an analysis condition corresponding to an idle stream as a candidate for analysis within each batch analysis, regardless of the analysis number. In this case, the stream can be used more effectively compared to the case where analyses are performed in order of analysis number within each batch analysis.

### (5-4. User-Specified Priority Analysis)

The control device 110 may also have a function to preferentially execute an analysis specified by the user, in addition to the criteria exemplified above. For example, when there is an analysis for which the user wants to check the analysis result earlier than other analyses, the user specifies that analysis as a “priority analysis” to be analyzed preferentially. It is also possible to set a priority order among priority analyses, and it may be configured such that priority analyses are executed in the order of the priority.

### (5-5. Sub-Summary)

As described above, an analysis that satisfies a predetermined criterion is selected as a candidate for the next analysis from among the unexecuted analyses. Then, from among the candidates, an analysis having an analysis condition corresponding to the stream configuration of the idle stream is determined as the next analysis. This allows the analysis to proceed in an analysis order that reflects the user's needs. Furthermore, by configuring it so that the user can select which of the predetermined criteria to adopt using the input device 14, the user can re-select the criterion each time the LC system 10 is used. Specifically, the user can select the stream-based criterion when placing the highest priority on throughput, the batch-based criterion when desiring the execution of analysis on a batch basis, and the plate-based criterion when desiring the execution of analysis on a sample plate 80 basis. With this configuration, the user can proceed with the analysis in an analysis order convenient for the user according to circumstances such as the purpose of the analysis, by a simple method. It is also possible to first analyze a priority analysis specified by the user. This allows the LC system 10 to realize analysis progress that meets the user's needs.

### 6. Flowcharts

Next, the processing of the control device 110 for realizing the above-described assignment of analysis will be described using flowcharts.

### (6-1. Analysis Assignment Process Based on Analysis Conditions and Stream Configuration)

FIG. 5 is a flowchart showing a process related to the control of the liquid chromatograph system according to the present embodiment.

In step (hereinafter referred to as “S”) S02, the control device 110 acquires the criterion related to the assignment of analysis selected by the input device 14. According to one embodiment, the user selects one from three criteria “stream-based criterion,” “batch-based criterion,” and “plate-based criterion” displayed on the display device 15 using the input device 14. Then, the input device 14 transmits the criterion selected by the user to the control device 110.

In S04, the analysis of analysis number 1 of a specific batch analysis is executed. The specific batch analysis may be, for example, the batch analysis with batch number 1, or may be a batch analysis selected by the user.

In S06, the control device 110 selects an analysis that satisfies a predetermined criterion from among the unexecuted analyses as a candidate for the next analysis.

In S08, the control device 110 determines whether there is an idle stream that is not performing an analysis among the plurality of streams included in the LC system 10. According to one embodiment, each stream transmits a signal indicating whether it is an idle stream or not to the control device 110. Then, the control device 110 determines whether each stream is an idle stream or not based on the signal.

If there is no idle stream (NO in S08), the control device 110 returns the process to S08.

If there is an idle stream (YES in S08), in S10, the control device 110 acquires information indicating the stream configuration of the idle stream. In one embodiment, information indicating the stream configuration of each stream is stored in the memory 12 of the control device 110. Then, the control device 110 acquires, from among that information, the information indicating the stream configuration of the stream that is an idle stream.

In S12, the control device 110 determines, from the candidates selected in S06, an analysis having an analysis condition corresponding to the stream configuration of the idle stream as the next analysis.

In S14, the control device 110 executes the analysis determined in S12 in the idle stream.

In S16, the control device 110 determines whether all analyses have been executed. If all analyses have been executed (YES in S16), the control device 110 ends the process.

If there are unexecuted analyses remaining (NO in S16), the control device 110 returns the process to S06.

According to the process of FIG. 5, it is possible to efficiently analyze samples with different analysis conditions using a liquid chromatograph system including a plurality of streams, in accordance with a criterion selected by the user.

### (6-2. Stream-Based Analysis Assignment Process)

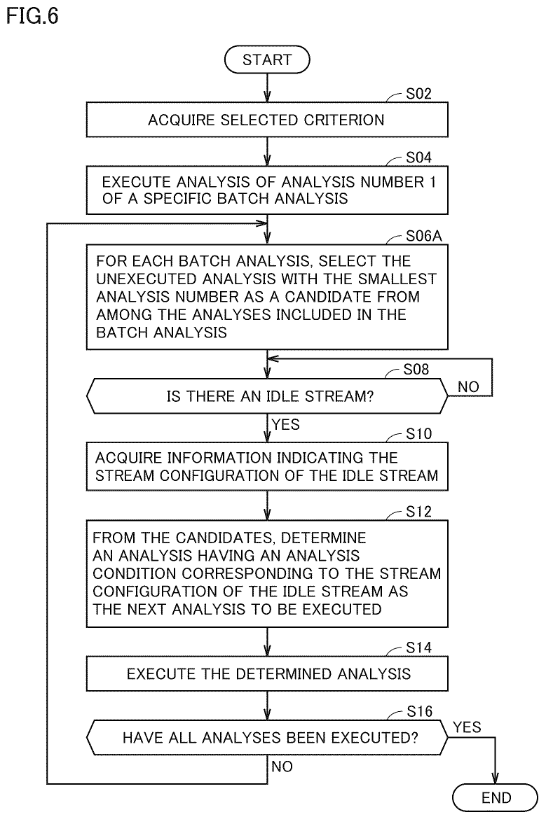

FIG. 6 is a flowchart for explaining a stream-based analysis assignment process.

In FIG. 6, S06 of FIG. 5 is replaced with S06A. Since the other steps in FIG. 6 are the same as in FIG. 5, their explanation is omitted.

In S06A, the control device 110 selects, for each batch analysis, the analysis that is unexecuted and has the smallest analysis number among the analyses included in the batch analysis, as a candidate for the next analysis.

According to the process of FIG. 6, it is possible to efficiently operate the streams and efficiently analyze samples with different analysis conditions using a liquid chromatograph system including a plurality of streams.

### (6-3. Batch-Based Analysis Assignment Process)

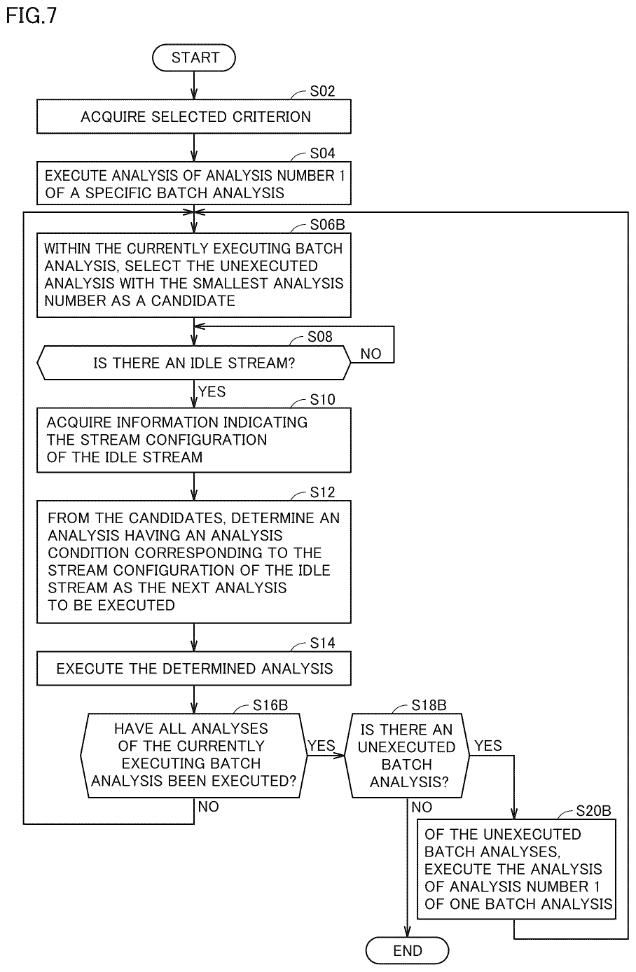

FIG. 7 is a flowchart for explaining a batch-based analysis assignment process. In the process of FIG. 7, the analysis of samples proceeds for each batch analysis.

In FIGS. 7, S06 and S16 of FIG. 5 are replaced with S06B and S16B, respectively. Furthermore, S18B to S20B are added. Since the other steps in FIG. 7 are the same as in FIG. 5, their explanation is omitted.

In S06B, the control device 110 selects, as a candidate for the next analysis, the unexecuted analysis with the smallest analysis number within the batch analysis that includes the analysis currently being executed in at least one of the plurality of streams.

In S16B, the control device 110 determines whether all analyses of the currently executing batch analysis have been executed.

If the currently executing batch analysis includes an unexecuted analysis (NO in S16B), the control device 110 returns the process to S06B.

When all analyses of the currently executing batch analysis are completed (YES in S16B), in S18B, the control device 110 determines whether there is an unexecuted batch analysis. An “unexecuted batch analysis” is a batch analysis in which each of all the analyses included in the batch analysis is an unexecuted analysis.

If all batch analyses are completed (NO in S18B), the control device 110 ends the process.

If there is an unexecuted batch analysis (YES in S18B), in S20B, the control device 110 executes the analysis with analysis number 1 of one of the unexecuted batch analyses, and then returns the process to S06B. An example of the one batch analysis is a batch analysis whose batch number is one greater than the batch analysis that was executed immediately before. In this case, there is a merit that it is easy for the user to grasp the progress status of all analyses. Another example of the one batch analysis is a batch analysis in which the analysis of analysis number 1 can be performed in a stream that is expected to become the next idle stream. A stream that is expected to become the next idle stream is, for example, a stream in which the analysis is expected to end soon. In this case, the stream can be used more effectively compared to the case of performing analyses in order of batch number. Yet another example of the one batch analysis is a batch analysis determined by an analysis order of batch analyses specified in advance by the user. In this case, the batch analysis for which the user wants to obtain the result early can be executed with priority.

According to the process of FIG. 7, it is possible to efficiently analyze samples with different analysis conditions using a liquid chromatograph system including a plurality of streams. Also, analysis can proceed on a batch analysis basis.

### (6-4. Plate-Based Analysis Assignment Process)

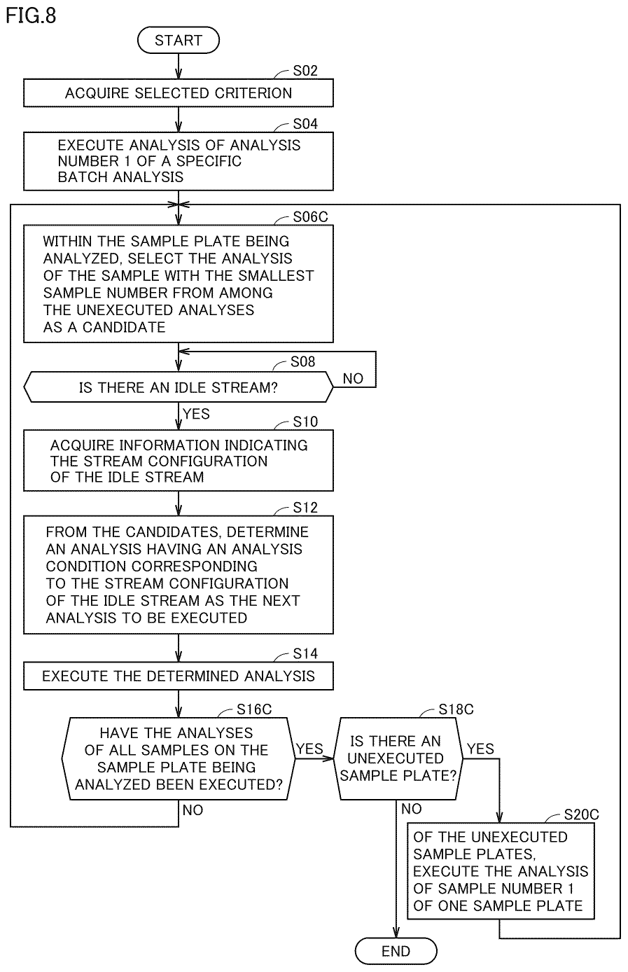

FIG. 8 is a flowchart for explaining a plate-based analysis assignment process. In the process of FIG. 8, the analysis of samples proceeds for each sample plate.

In FIGS. 8, S06 and S16 of FIG. 5 are replaced with S06C and S16C, respectively. Also, S18C to S20C are added. Since the other steps in FIG. 8 are the same as in FIG. 5, their explanation is omitted.

In S06C, the control device 110 selects, as a candidate for the next analysis, the unexecuted analysis with the smallest analysis number within the sample plate 80 that contained the sample of the analysis currently being executed in at least one of the plurality of streams.

In S16C, the control device 110 determines whether the analyses of all samples on the sample plate being analyzed have been executed.

If the sample plate being analyzed includes a sample whose analysis has not been executed (NO in S16B), the control device 110 returns the process to S06C.

When the analyses of all samples on the sample plate being analyzed are completed (YES in S16C), in S18C, the control device 110 determines whether there is a sample plate whose analysis has not been executed. An “unexecuted sample plate” is a batch analysis in which each of the analyses corresponding to all samples accommodated on the sample plate is an unexecuted analysis.

If analysis has been completed for all sample plates (NO in S18C), the control device 110 ends the process.

If there is a sample plate that has not been analyzed (YES in S18C), in S20C, the control device 110 executes the analysis of sample number 1 on one of the sample plates, and then returns the process to S06C. An example of the one sample plate is a sample plate whose plate number is one greater than the sample plate that was executed immediately before. In this case, there is a merit that it is easy for the user to grasp the progress status of all analyses. Another example of the one sample plate is a sample plate on which the analysis of sample number 1 can be performed in a stream that is expected to become the next idle stream. In this case, the stream can be used more effectively compared to the case of performing analyses in order of plate number. Yet another example of the one sample plate is a sample plate determined by an analysis order of sample plates specified in advance by the user. In this case, the analysis of the sample plate for which the user wants to obtain the result early can be executed with priority.

According to the process of FIG. 8, it is possible to efficiently analyze samples with different analysis conditions using a liquid chromatograph system including a plurality of streams. Also, analysis can proceed on a sample plate basis.

### (6-5. Priority Analysis Execution Process)

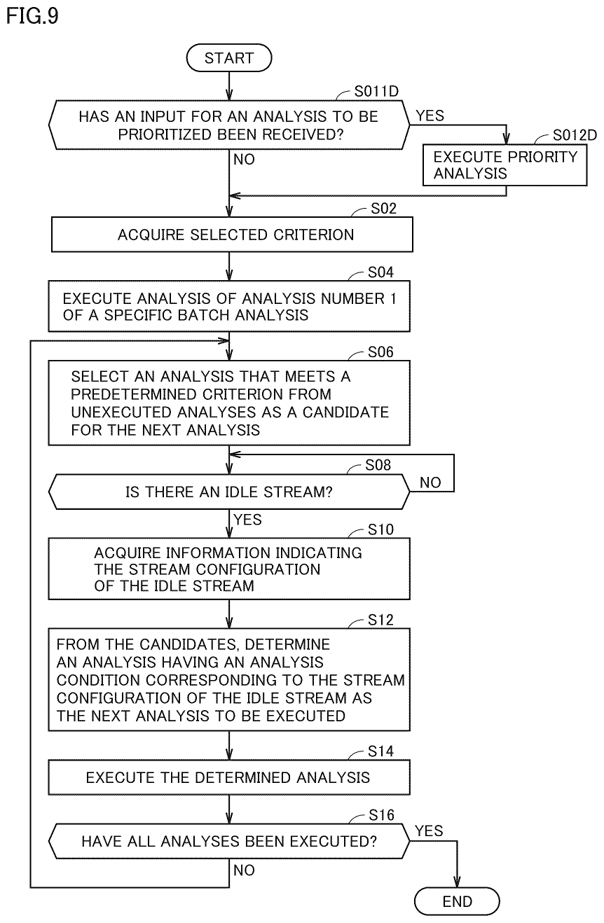

FIG. 9 is a flowchart for explaining a priority analysis execution process.

In FIG. 9, S011D and S012D are added before S02 of FIG. 5. Since the other steps are the same as in FIG. 5, their explanation is omitted.

In S011D, the control device 110 determines whether an input of an analysis to be prioritized has been received. In one embodiment, the user, as necessary, selects an analysis to be executed with priority from among the analyses displayed on the display device 15 using the input device 14. Then, the input device 14 transmits information regarding the analysis selected by the user to the control device 110.

If an input of an analysis to be prioritized has been received (YES in S011), in S012D, the control device 110 executes the selected analysis as a priority analysis before other analyses.

If an input of an analysis to be prioritized has not been received (NO in S011), the control device 110 proceeds to S02.

According to the process of FIG. 9, in addition to being able to efficiently analyze samples with different analysis conditions using a liquid chromatograph system including a plurality of streams, it is possible to first execute an analysis to be prioritized selected by the user.

### 7. Display of Analysis Progress

As described above, the LC system 10 proceeds with all analyses according to a criterion selected by the user from among a plurality of criteria. Therefore, the execution order of analyses can also differ for each criterion. In particular, when all analyses are proceeding on a stream basis, since each batch analysis is advanced in parallel, it is difficult for the user to understand the progress within each batch.

Therefore, in the LC system 10, by displaying the progress status for each batch analysis on the display device 15, user understanding is assisted.

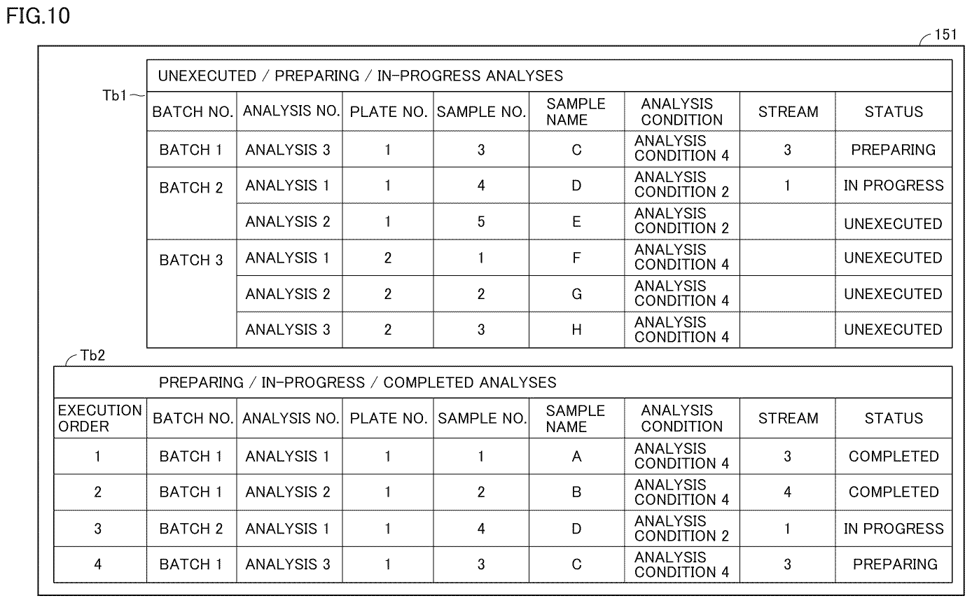

FIG. 10 is an example of a display screen 151 showing the progress status of all analyses. The display screen 151 is displayed on the display device 15.

Referring to FIG. 10, the display screen 151 includes a table Tb1 and a table Tb2. Table Tb1 is a table that displays information on unexecuted analyses. In the example of FIG. 10, table Tb1 also displays information on analyses that are in preparation and analyses that are in progress. “In preparation” refers, for example, to a state where the next sample to be analyzed has been determined in a stream where the previous analysis has been completed, and preparation for the next analysis is being performed.

Table Tb1 displays each analysis for each batch analysis and displays information related to each analysis. Specifically, table Tb1 includes items such as “Batch No.,” “Plate No.,” “Sample No.,” “Sample Name,” “Analysis Condition,” “Stream,” and “Status.” A corresponding value is displayed in the column corresponding to each item. For example, the value corresponding to the “Status” item is one of “Preparing,” “In Progress,” or “Unexecuted.”

Table Tb2 is a table that displays information on completed analyses. In the example of FIG. 10, table Tb1 also displays information on analyses that are in preparation and analyses that are in progress.

In table Tb2, analyses are displayed in the order in which they were executed, including preparation, and information related to the analysis is displayed. Table Tb2 includes the same items as table Tb1 and an item for the “Execution Order” of the analysis. A corresponding value is displayed in the column corresponding to each item. However, the value corresponding to the “Status” item in table Tb2 is one of “Preparing,” “In Progress,” or “Completed.”

Using the display screen 151, the user can easily confirm the analyses that have not been completed in the stream by looking at table Tb1. Furthermore, the user can easily confirm whether each of the analyses included in the uncompleted analyses is an unexecuted analysis, an analysis in preparation, or an analysis in progress.

In particular, by displaying the analyses for each batch analysis in table Tb1, the progress of each batch analysis can be easily grasped. For example, it can be easily understood up to what number analysis and/or what percentage of analysis is unexecuted in each batch analysis. Also, since a batch analysis for which all analyses have been completed is not displayed in table Tb1, by checking the batch number column of table Tb1, the batch analysis for which all analyses have been completed can be easily found.

Also, by visually confirming the method of the analysis with unexecuted status, it is possible to infer the stream to be used.

It is also possible to find a sample plate 80 for which the execution of all samples has been completed.

On the other hand, the user can confirm the analyses for which the start of the analysis, including preparation, has already been performed in the stream by looking at table Tb2. Furthermore, the user can easily confirm whether each of the analyses included in the analyses for which the start has already been performed is an analysis in preparation, an analysis in progress, or a completed analysis.

Also, in table Tb2, it can be confirmed in what order these analyses were performed. For example, it can be understood which batch analysis was executed early and which batch analysis is progressing slowly.

It is also possible to find a batch analysis for which all analyses have been completed, and a sample plate 80 for which the analyses of all samples have been completed.

As described above, according to the display screen 151, the user can intuitively grasp the progress status of all analyses. Specifically, the user can easily read a plurality of important pieces of information related to the analysis from two simple tables. This can suppress the occurrence of inconvenience and stress for the user due to the difficulty in understanding the progress status of all analyses or each batch analysis. For example, the user can easily grasp the progress status of all analyses and wait for all analyses to be completed while recognizing that the progress is smooth. This also makes it easy for the user to perform other tasks in parallel during the analysis of all analyses in the LC system 10. Also, since it is easy to have an overall perspective of the analysis, it is also easy to make a schedule for other tasks to be performed after all analyses are completed.

In particular, even when a plurality of batch analyses are being executed in parallel under the stream-based criterion and the plate-based criterion, the user can easily grasp the progress status of each batch analysis. This improves work efficiency because the analysis results of the completed batches can be examined without waiting for all analyses to be completed.

The display screen 151 may also include other useful information for the user, such as the name of the criterion selected by the user, the status of each stream (for example, status such as analysis in progress, analysis in preparation, idle stream, etc.), an estimated value of the time required for all analyses calculated by the control device 110, and the like.

### ASPECTS

It is understood by those skilled in the art that the plurality of exemplary embodiments described above are specific examples of the following aspects.
(Item 1) A liquid chromatograph system according to one aspect is a liquid chromatograph system for performing analysis of a plurality of samples. The liquid chromatograph system comprises a plurality of streams, a sample injection device, a detector, and a control device. The plurality of streams separate samples. The sample injection device injects a sample into each of the plurality of streams. The detector is disposed downstream of the plurality of streams and analyzes the sample separated in each of the plurality of streams. The control device stores, for each sample, analysis conditions for separating the sample. Each of the plurality of streams includes a column and a supply device. The column separates the sample injected into the stream. The supply device supplies a mobile phase used in the column. The plurality of streams include at least two streams having stream configurations related to sample separation that are different from each other. The control device selects a stream having a stream configuration corresponding to the analysis conditions of the sample from among the plurality of streams.

According to the liquid chromatograph system described in Item 1, even for analyses of samples with different analysis conditions, a stream capable of implementing each analysis condition can be selected and executed. Therefore, it is possible to efficiently analyze samples with different analysis conditions using a liquid chromatograph system including a plurality of streams.
(Item 2) In the liquid chromatograph system according to Item 1, the analysis condition is at least one of the type of mobile phase supplied to the column and the type of the column.

According to the liquid chromatograph system described in Item 2, it is possible to efficiently analyze samples with different analysis conditions in at least one of the type of mobile phase and the type of column, using a liquid chromatograph system including a plurality of streams.
(Item 3) In the liquid chromatograph system according to Item 1 or 2, the supply device includes a container and a pump. The container stores a predetermined type of mobile phase. The pump supplies the mobile phase stored in the container to the column. The stream configuration includes at least one of the type of mobile phase stored in the container and the type of the column.

According to the liquid chromatograph system described in Item 3, it is possible to efficiently analyze samples with different analysis conditions in at least one of the type of mobile phase and the type of column, using a liquid chromatograph system including a plurality of streams.
(Item 4) In the liquid chromatograph system according to any one of Items 1 to 3, when at least one stream of the plurality of streams is an idle stream in which analysis is not being performed, the control device determines an analysis whose analysis conditions correspond to the stream configuration of the idle stream as the next analysis to be performed next in the idle stream.

According to the liquid chromatograph system described in Item 4, when a previous analysis in a stream is completed and it becomes an idle stream, an analysis that can be performed in the idle stream can be searched for and started. This allows the stream to be used effectively, thereby improving the throughput of the analysis system.
(Item 5) In the liquid chromatograph system according to Item 4, the control device selects an analysis that satisfies a predetermined criterion from among unexecuted analyses as a candidate for the next analysis. Then, the control device determines, from among the candidates, an analysis having an analysis condition corresponding to the stream configuration of the idle stream as the next analysis.

According to the liquid chromatograph system described in Item 5, it is possible to proceed with the analysis in an analysis order that reflects the user's needs.
(Item 6) In the liquid chromatograph system according to Item 5, the analysis of the plurality of samples includes one or more batch analyses. A batch analysis includes a plurality of analyses to which analysis numbers are assigned.

According to the liquid chromatograph system described in Item 6, the control device can select an appropriate stream and perform the analysis even when there are analyses with mutually different analysis conditions in an analysis managed in a batch format.
(Item 7) In the liquid chromatograph system according to Item 5 or 6, the predetermined criterion is a first criterion of selecting an unexecuted analysis from the analyses included in the batch analysis for each batch analysis, and setting it as a candidate.

According to the liquid chromatograph system described in Item 7, the time required to execute all analyses can be further shortened compared to each of the second criterion and the third criterion described later.
(Item 8) In the liquid chromatograph system according to Item 5 or 6, the predetermined criterion is a second criterion of setting an unexecuted analysis within the batch analysis that includes the currently executing analysis as a candidate.

According to the liquid chromatograph system described in Item 8, as soon as the analysis for a batch analysis unit is completed, the results can be used sequentially.
(Item 9) The liquid chromatograph system according to Item 5 or 6, further comprising one or more sample plates, each accommodating one or more samples. The predetermined criterion is a third criterion of setting an unexecuted analysis from among the sample plates that contained the sample of the currently executing analysis as a candidate.

According to the liquid chromatograph system described in Item 9, as soon as the analysis for a sample plate unit is completed, the results can be used sequentially.
(Item 10) In the liquid chromatograph system according to any one of Items 5 to 9, the control device includes an input device capable of selecting an analysis of a sample. The control device analyzes the analysis selected using the input device prior to other analyses.

According to the liquid chromatograph system described in Item 10, an analysis to be prioritized selected by the user can be executed first.
(Item 11) In the liquid chromatograph system according to any one of Items 5 to 10, the control device includes an input device. The predetermined criterion is a criterion selected by the user using the input device.

According to the liquid chromatograph system described in Item 11, the user can proceed with the analysis in an analysis order convenient for the user according to circumstances such as the purpose of the analysis, by a simple method.
(Item 12) The liquid chromatograph system according to Item 6, wherein the control device further includes a display device that displays the progress status for each batch analysis.

According to the liquid chromatograph system described in Item 12, the user can easily understand the progress status of all analyses or each batch analysis. This can suppress the occurrence of inconvenience and stress for the user due to the difficulty in understanding the progress status of all analyses or each batch analysis.
(Item 13) A control method according to another aspect is a control method for a liquid chromatograph system for performing analysis of a plurality of samples, executed by a computer. The liquid chromatograph system comprises a plurality of streams, a sample injection device, and a detector. The plurality of streams separate samples. The sample injection device injects a sample into each of the plurality of streams. The detector is disposed downstream of the plurality of streams and analyzes the sample separated in each of the plurality of streams. Each of the plurality of streams includes a column and a supply device. The column separates the sample injected into the stream. The supply device supplies a mobile phase used in the column. The plurality of streams include at least two streams having stream configurations related to sample separation that are different from each other. The control method comprises a step of selecting a stream having a stream configuration corresponding to the analysis conditions for separating the sample from among the plurality of streams, and a step of executing the analysis of the sample in the selected stream.

According to the method described in Item 13, even for analyses of samples with different analysis conditions, a stream capable of implementing each analysis condition can be selected and executed. Therefore, it is possible to efficiently analyze samples with different analysis conditions using a liquid chromatograph system including a plurality of streams.

The embodiments disclosed this time should be considered illustrative in all respects and not restrictive. The scope of the present invention is indicated by the claims rather than by the description of the embodiments above, and all changes that come within the meaning and range of equivalency of the claims are intended to be embraced therein.

### DESCRIPTION OF REFERENCE NUMERALS

60A, 60B, 60C, 60D Stream, 70A Column, 10 LC system, 11 Processor, 12 Memory, 13 Input/output I/F, 14 Input device, 15 Display device, 18 Sample injection device, 20A Mobile phase container, 30A Mixer, 180A Valve, 40A Mobile phase pump, 50A Supply device, 80 Sample plate, 90 Divert valve, 91, 92, 93, 94, 95, 96 Port, 100 Analysis device, 110 Control device, 111 Main body, 151 Display screen, 292 Detector flow path, 500 Detector.

1. A liquid chromatograph system for performing analysis of a plurality of samples, wherein the liquid chromatograph system comprises:
a plurality of streams for separating a sample;
a sample injection device for injecting a sample into each of the plurality of streams;
a detector disposed downstream of the plurality of streams for analyzing the sample separated in each of the plurality of streams; and
a control device for storing, for each sample, analysis conditions for separating the sample, wherein each of the plurality of streams includes:
a column for separating the sample injected into the stream; and
a supply device for supplying a mobile phase used in the column,
wherein the supply device includes:
a container for storing a predetermined type of mobile phase; and
a pump for supplying the column with the mobile phase stored in the container,
wherein the plurality of streams include at least two streams having stream configurations related to sample separation, each stream configuration including a different combination of a type of the mobile phase stored in the container and a type of the column, and
wherein the control device selects from the plurality of streams a stream having a stream configuration corresponding to the analysis conditions of the sample, the analysis conditions being a combination of a type of the mobile phase supplied to the column and a type of the column.

2. (canceled)

3. (canceled)

4. The liquid chromatograph system according to claim 1, wherein the control device, when at least one stream of the plurality of streams is an idle stream in which analysis is not being performed, determines an analysis whose analysis conditions correspond to the stream configuration of the idle stream as a next analysis to be performed next in the idle stream.

5. The liquid chromatograph system according to claim 4, wherein the control device selects an analysis that satisfies a predetermined criterion from among unexecuted analyses as a candidate for the next analysis, and
determines, from among the candidates, an analysis having an analysis condition corresponding to the stream configuration of the idle stream as the next analysis.

6. The liquid chromatograph system according to claim 5, wherein the analysis of the plurality of samples includes one or more batch analyses, and
a batch analysis includes a plurality of analyses to which analysis numbers are assigned.

7. The liquid chromatograph system according to claim 5, wherein the predetermined criterion is a first criterion of selecting an unexecuted analysis from the analyses included in the batch analysis for each batch analysis, and setting it as the candidate.

8. The liquid chromatograph system according to claim 5, wherein the predetermined criterion is a second criterion of setting an unexecuted analysis within a batch analysis that includes a currently executing analysis as the candidate.

9. The liquid chromatograph system according to claim 5, further comprising one or more sample plates, each accommodating one or more samples,
wherein the predetermined criterion is a third criterion of setting an unexecuted analysis from among sample plates that contained a sample of a currently executing analysis as the candidate.

10. The liquid chromatograph system according to claim 5, wherein the control device includes an input device capable of selecting an analysis of a sample, and
the predetermined criterion is a fourth criterion of analyzing an analysis selected using the input device prior to other analyses.

11. The liquid chromatograph system according to claim 5, wherein the control device includes an input device, and
the predetermined criterion is a criterion selected by a user using the input device.

12. The liquid chromatograph system according to claim 6, wherein the control device further includes a display device that displays a progress status for each batch analysis.

13. A control method for a liquid chromatograph system for performing analysis of a plurality of samples, executed by a computer,
wherein the liquid chromatograph system comprises:
a plurality of streams for separating a sample;
a sample injection device for injecting a sample into each of the plurality of streams; and
a detector disposed downstream of the plurality of streams for analyzing the sample separated in each of the plurality of streams,
wherein each of the plurality of streams includes:
a column for separating the sample injected into the stream; and
a supply device for supplying a mobile phase used in the column,
wherein the supply device includes:
a container for storing a predetermined type of mobile phase; and
a pump for supplying the column with the mobile phase stored in the container,
wherein the plurality of streams include at least two streams having stream configurations related to sample separation, each stream configuration including a different combination of a type of the mobile phase stored in the container and a type of the column,
the control method comprising:
a step of selecting from the plurality of streams a stream having a stream configuration corresponding to analysis conditions for separating the sample, the analysis conditions being a combination of a type of the mobile phase supplied to the column and a type of the column; and
a step of executing the analysis of the sample in the selected stream.
